(19) United States
(12) Patent Application Publication
(10) Pub. No.: US 2009/0282737 A1
(43) Pub. Date: Nov. 19, 2009

(54) Plant Flat Shipping Device

(76) Inventor: Ethan Adam Argo, Somerville, TN (US)

Correspondence Address: CORDTS AND GULLEY, PLLC, 6283 POPLAR AVENUE, SUITE 1132, MEMPHIS, TN, 38119, US

(21) Appl. No.: 12/120,542

(22) Filed: May 14, 2008

(51) Int. Cl. A01G 9/02

(52) U.S. Cl. 47/84

(57) ABSTRACT

The present invention is directed to a flower flat compartment retention device to assist in storage and transportation of plants in flower flats. The invention comprises a retention means to prevent the accidental dislodging of the contents of a flower flat compartment during storage and transportation of said flower flat.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND

### Field of the Invention

The present invention relates to a retention device to assist in storage and transportation of plants in flower flats.

### SUMMARY

The present invention is directed to a flower flat compartment retention device to assist in storage and transportation of plants in flower flats. The invention comprises a retention means to prevent the accidental dislodging of the contents of a flower flat compartment during storage and transportation of said flower flat.

### BRIEF DESCRIPTION OF THE SEVERAL VIEWS OF THE DRAWINGS

These and other features, aspects, and advantages of the present invention will become better understood with regard to the following description, appended claims, and accompanying drawings where:

FIG. 1 is a perspective view from above the flower flat of the embodiment shown in FIG. 1.

FIG. 2 is a close-up perspective view from above the flower flat compartment of the embodiment shown in FIG. 1.

### DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. It is intended that the present invention cover modifications and variations as come within the scope of the appended claims and their equivalents.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

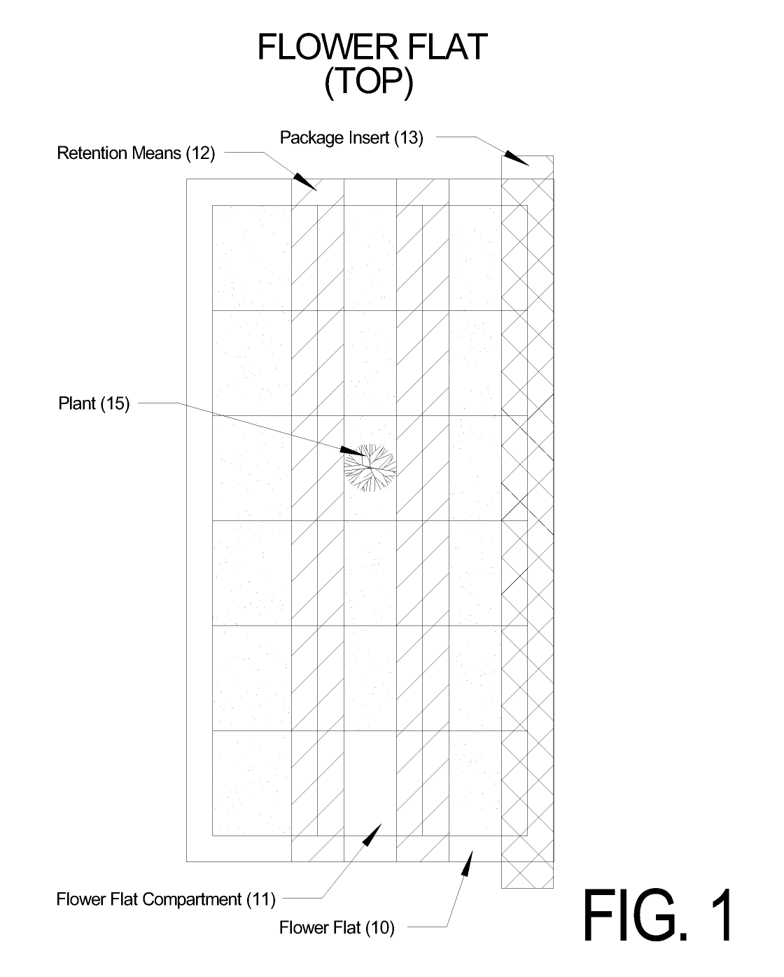

FIG. 1 shows a traditional flower flat at 10 according to an embodiment of the present invention. FIG. 1 further shows the flower flat compartments 11 which are structurally part of the flower flat 10. FIG. 1 further shows a retention means 12. In a preferred embodiment, the retention means 12 is comprised of batten tape, though it could consist of any other material. The retention means 12 strategically overlays the common walls of the flower flat compartments 11. In a preferred embodiment, the retention means 12 is taut and connected at each end of the flower flat 12. Though shown in one configuration here, the retention means 12 could easily be extended to completely encircle the flower flat 10, be drawn taut, and be secured to itself.

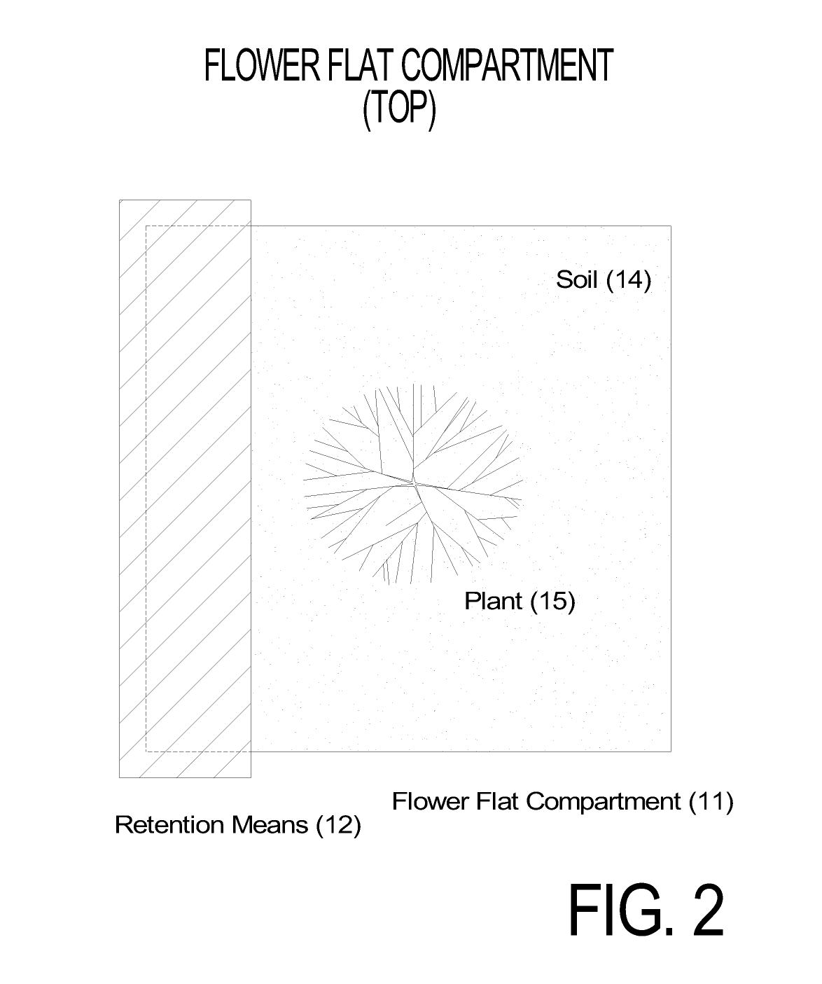

As best seen in FIG. 2, the retention means 12 extends to cover a portion of the soil 14 contained within the flower flat compartment 11. The retention means 12 does not cover the portion of the flower flat compartment 11 where the plant 15 emerges from the soil 14, and therefore, does not interfere with the proper growth of the plant 15.

In the preferred embodiment, the retention means 12 is ran only lengthwise along the portions of the flower flat 10 that fall between the columns of flower flat compartments 11. The retention means 12 could also be run widthwise along the portions of the flower flat 10 that fall between the columns of flower flat compartments 11. A package insert 13, commonly used in the industry, serves to anchor the exposed outside edges of the flower flat compartments 11 located along each side of the flower flat 10. Additional retention means 12 could be placed along the outside edges of the flower flat 10 in place of the package insert 13 and effectively eliminate the need for the use of package inserts 13.

Although the present invention has been described and illustrated with respect to a preferred embodiment and a preferred use therefore, it is not to be so limited since modifications and changes can be made therein which are within the full intended scope of the invention.

What is claimed is:

1. A flower flat compartment retention device, the flower flat compartment retention device comprising:
(a) a traditional flower flat with the flower flat compartments containing soil, with or without plants; and
(b) a retention means located above and along the portions of the flower flat that fall between the columns of flower flat compartments, for preventing the accidental dislodging of flower flat compartment contents.
